(19) United States
(12) Patent Application Publication
(10) Pub. No.: US 2026/0110666 A1
(43) Pub. Date: Apr. 23, 2026

(54) LOW FREQUENCY PULSE ULTRASONIC SYSTEM AND METHOD FOR NON-INTRUSIVE EVALUATION OF MULTI-LAYERED INDUSTRIAL STRUCTURES

(71) Applicant: Hatch Ltd., Mississauga (CA)

(72) Inventor: Afshin SADRI, Mississauga (CA)

(21) Appl. No.: 19/121,895

(22) PCT Filed: Oct. 20, 2023
(86) PCT No.: PCT/CA2023/051401

§ 371 Date: Apr. 17, 2025

Related U.S. Application Data
(60) Provisional application No. 63/418,306, filed on Oct. 21, 2022.

(51) Int. Cl. G01N 29/34; G01N 29/24

(52) U.S. Cl. CPC G01N 29/348; G01N 29/2437; G01N 2291/0231; G01N 2291/02854

(57) ABSTRACT

A system and method for measuring thicknesses of one or more thin layers in a multi-layered industrial structure. One of the layers may comprise a coarse-grained material. The multi-layered structure may be less than 600 mm thick. The method comprises emitting ultrasonic pulses into the multi-layered industrial structure and detecting thickness frequencies of the layers of the structure and comparing against known thickness frequencies. The ultrasonic pulses being a frequency sweep pulse or a broadband frequency sweep pulse uniquely programmed for the multi-layered structure.

### FIELD

The present invention relates to the field of multi-layered industrial structures and using ultrasonic waves for their non-intrusive evaluation.

### BACKGROUND

Multi-layered linings in industrial structures sometimes comprise two or more layers of material that may be of different thicknesses, material and/or mechanical properties. In some cases only one side, or an exterior layer, of such structures is accessible to a user, but information (such as the wear or status) about other side(s), and/or the internal and within the structure(s), and/or one or more internal layers is desired and which may not be accessible to the user. For example, some metallurgical furnaces or chemical process vessels comprise sidewalls with a multi-layer construction, including a steel shell accessible on the outside (or the cold side) of the furnace, and inner layers comprising one or more layers of refractory brick and castables, cooling elements of cast copper and/or cooling elements of cast iron, that are not accessible (such as during use of the furnace, or only accessible by intrusive testing). The inner layers, including the layer directly in contact with the inside of the furnace cavity (or the hot side), may suffer from wear or deterioration due to activity inside the furnace, which may become problematic if undetected. For example, during operation, the refractory lining of a furnace can be deteriorated by mechanical changes such as abrasion and thermal stress in addition to chemical degradation resulting in a loss of overall refractory lining or cooling element thickness. Deterioration of the refractory lining, or in other examples deterioration of cooling elements, can lead to structural failures that may cause the outer steel shell to be exposed to molten materials and aggressive chemicals from inside the furnace. This may result in severe injury to personnel working near the furnace if such materials erode through the outer shell. Even if the issue is detected in time to prevent injury to personnel, if the issue is not detected soon enough it can lead to more down time of the furnace and greater overall damage to the furnace, resulting in financial losses and extensive damages to the environment, than if the issue has been detected sooner. A method and system for non-destructively evaluating a change in one or more layers of a multi-layer furnace structure is desired.

U.S. Pat. No. 9,791,416 describes an acoustic monitoring system for smelting furnaces and similar devices. The acoustic monitoring system can be used to identify locations of potential failure in thick multi-layered furnace walls.

Thicknesses of layers in a thin multi-layered structure, for example thicknesses measuring less than about 600 mm, cannot however be measured within the desired accuracy range using any known acoustic monitoring systems.

### BRIEF DESCRIPTION OF THE FIGURES

FIG. 1 shows an example graph of a chirp pulse.

FIG. 2 shows an example graph of a toneburst pulse.

FIG. 3 shows an example system for determining wear in a first layer of a multi-layered structure according to embodiments of this disclosure.

### DETAILED DESCRIPTION

An ultrasonic system and method for evaluating a change in a layer of a multi-layered industrial structure is provided. Industrial structures may include, for example, any process vessel or furnace structure that comprises refractory, staves, cooling blocks, for example such as metallurgical furnaces, glass furnaces, kilns and autoclaves, among others. The evaluation may relate to changes in thickness, material or mechanical properties of the layer. Material properties may be for example any intensive property such as temperature, refractive index, density, and hardness. Mechanical properties may include for example, strength, ductility, hardness, impact resistance, and fracture toughness. The thickness may be described as the dimension of the material in one direction, for example taken by a length measurement. A thin multi-layered furnace structure may be for example a structure comprising a thickness of less than about 600 mm, for example, less than about 500 mm, less than about 300 mm, less than about 250 mm, less than about 200 mm, less than about 150 mm or less than about 100 mm or less than about 50 mm. In an example, the ultrasonic system and method as disclosed herein may be for evaluating a change in a layer of the lining of a metallurgical furnace. Because of the need for industrial structures such as metallurgical furnaces to have strength due to the hostile environment in which they operate, no single layer of a furnace structure for which embodiments of this invention relates would be less than 20 mm thick. For example, the thinnest structural component of a metallurgical furnace or chemical process vessel lining may be the outer shell which is typically no less than 20 mm. Other structural components or layers of the metallurgical furnace or chemical process vessel may be more than 20 mm but less than 600 mm. Although 20-600mm may be a relatively thin industrial structure, this thickness is relatively thick in comparison to elements for example that would be found in consumer electronic devices or electronic components.

The deterioration of the structural elements in an industrial structure, for example in a process vessel or metallurgical furnace, is not limited to the refractory brick or castables. The deterioration could include deterioration of any layer of the structure, such as the cooling blocks or staves or build-up or accretion. For example, the cooling elements in some metallurgical furnaces may be the inner third layer of the walls and could deteriorate due to thermo-mechanical and thermo-chemical conditions in the furnace. The ultimate wear of the cooling elements may result in the release of cooling fluid or water into the furnace or the process vessel and result in damage or failure of the vessel, and negative consequential health, safety and/or financial outcomes. The invention herein may measure thickness of refractory, cooling blocks, or any other layer; or may detect changes in any one or more of mechanical properties, material properties and thickness of refractory, cooling blocks or other layers; and thereby evaluate non-intrusively such furnace structures using the data gathered to help prevent partial or complete cooling block, refractory, shell and furnace or process vessel failure.

The change in thicknesses of the one or more layers of an industrial structure that the system and method of the present disclosure may detect may be related to the wavelength or frequency of the acoustic signal being sent. Furnace structures, for example, glass furnace or metallurgical furnace walls, rotary kilns, thin refractory linings, furnace stave coolers, multi-layered pipes, concrete and masonry equipment, and other hot or chemical process vessels with wall layer thicknesses under about 600 mm, may be too thin to accurately measure using a conventional acoustic impact measurement techniques. This may be the case because the acoustic waves resulting from impacting a hammer against a structure comprises half wavelengths that are longer than the thickness of the layer to be evaluated within the structure. Acoustic pulses conventionally fall within the 20 Hz to 20 KHz frequency range and therefore have wavelengths that are much too long for measuring individual layers within a furnace structure, for example. In conventional acoustic impact systems and methods, a shadow zone emerges below the impact or wave generation source when the thickness of a layer is less than the half wavelength of the pulse. This may inhibit measurement of the first layer thickness or produce inaccurate results because the thickness of the primary layer is too small for a full wave to propagate.

A layer thickness that is less than at least half the wavelength of the impact pulse cannot be determined because a full wave cannot propagate through the thickness to produce any useable information. In addition, the impact pulser used in prior art methods, for example a hammer, can only emit acousto ultrasonic waves with an unknown and/or uncontrollable wavelength. In another known example, spherical impact sources have been used to generate broadband stress waves, elastic waves and/or shock waves. However, the bandwidth frequencies and the range of frequencies produced from the spherical impact source depend on the contact time of impact and the diameter of the spherical impact source. Prior art acousto ultrasonic emission systems using impact pulsers are therefore insufficient to produce repeatable and accurate thickness measurements or measurements for evaluating changes in thickness, material and/or mechanical properties of thin multi-layered industrial structures. In an aspect of this invention, a wave emitter is controlled to produce one or more select ultrasonic waves having a specific range of frequencies and wavelengths selected to cause at least one layer in a multi-layered industrial structure to produce a return signal that is indicative of a property of the layer.

Aspects of this invention are intended for measuring the thickness of, change in thickness of, and/or other changes in material or mechanical properties of (such as detection of artifacts or other changes or delamination in) one or more layers of a multi-layers industrial structure. The multi-layered industrial structure may comprise at least one layer comprising a coarse-grained, heterogenous, or composite material. Collectively this is referred to as evaluating one or more layers of the multi-layered industrial structure. For example, this multi-layered industrial structure may comprise a coarse-grained or heterogeneous layer, or a coarse-grained layer in a structure comprising one or more layers of coarse-grained material, fine-grained material, soft material or a combination of any of the aforementioned materials. The coarse-grained layer for which the thickness, material and or mechanical properties are being evaluated or measured using the system and method of this invention may be behind another coarse-grained layer. A course-grained material may comprise crystals that are large, and may comprise multiple sizes and/or types of crystals. Coarse-grained materials may be for example heterogeneous, composite materials and may include for example concrete, wood, rock, refractory brick, cast copper, bone, and cast iron. Fine-grained and soft materials by contrast may be for example homogeneous, non-composite materials and may include for example aluminum bars.

In an aspect of this invention, a method is provided for measuring layer thickness, changes in layer thickness, changes in mechanical properties, and/or changes in material properties of a multi-layered industrial structure using ultrasonic waves. The one or more layer(s) of the structure measured using this method may be individually or collectively less than about 600 mm thick but greater than 20 mm thick. The method comprises emitting a frequency sweep pulse or a broadband pulse into the multi-layered structure. A frequency sweep or broadband pulse emits a range of frequencies within a selected upper and lower limit frequency boundary. For example, an ultrasonic frequency sweep or broadband pulse may be selected to emit frequencies in the range of 20 kHz-200 kHz. Frequencies emitted at higher than 200 kHz may dissipate in course-grain structures and accordingly may not be desirable or function with the present invention. The emission may come from a first side of the structure and reflect at one or more of the boundaries between the layers of the structure and the opposite side of the structure. The reflected frequencies (i.e. the frequencies of the signal(s) that are returned from the multi-layered structure) may not be the same as the emitted signal frequency range. The reflected frequency of each layer is related to the thickness and material properties and density of the layers, and may be higher or lower than the emitted frequency range. For example the reflected frequency may be as low as 3 kHz or lower for very thick, low density layers, and up to 1200 kHz or higher for very thin, high density layers. The frequency sweep pulse or broadband pulse may be for example a chirp pulse or a controlled toneburst pulse. For brevity, the frequency sweep pulse or broadband pulse will be referred to as a sweep pulse throughout this disclosure but may be any type of frequency sweep or broadband pulse in the ultrasonic range. The ultrasonic range of the transmitted frequencies includes frequencies above 20 kHz, and preferably frequencies in the range of low frequency ultrasonic, such as for example between about 20 kHz and 200 kHz.

The sweep pulse may be selected/programmed based on the thicknesses of the layers, the mechanical properties and/or the material properties, of the multi-layered structure, for example based on the P-wave or longitudinal wave speed in at least one of the layers, or a combination of the wave speeds for all of the layers of a the multi-layered structure. Selecting the aspects of the sweep pulse comprises controlling an ultrasonic wave-transmitting device to produce the ultrasonic waves of the desired sweep pulse properties. In an example, the sweep pulse is selected to comprise wavelengths whose half-wavelength is smaller than the thickness of the thinnest layer in the industrial structure to be evaluated. The sweep pulse may be provided such that the upper limit, or lowest frequency, of the pulse's bandwidth (i.e. the range of frequencies of the pulse) corresponds to the overall thickness of the multi-layered structure and the lower limit, or highest frequency, corresponds to the thickness of the smallest layer of the multi-layered structure. In some cases, the smallest layer may be the layer of interest to be measured, or the layer of interest may be another layer in the structure. The sweep pulse duration, that is, the length of time it takes the pulse to emit the full range of selected frequencies, may also be programmed to create the desired excitation frequency (i.e. the selected frequency range, for example formed by vibration of the transmitter emitting the pulse). For example, the desired excitation frequency may be between 20 kHz and 150 kHz or any other desired range based on the structure, material and layer thickness frequency(s). For example, the frequency for a layer with high density or low porosity may be higher because the wave can move through the material faster, whereas a low density or high porosity layer of the same thickness may have a lower frequency.

In an embodiment, a single layer frequency is calculated for a castable to have a P-wave speed of 3000 m/s, at a thickness of 150 mm, the thickness frequency being 10000 Hz or 10 kHz. To select the chirp frequency a 20 KHz to 200 kHz pulse has frequencies above the pre-computed thickness frequency of a layer (small half wavelengths than the thickness). In the event of three layers, for example, there is a thickness of the first layer T1, 150 mm, 2nd layer T2, 200 mm and the 3rd layer T3, 180 mm, with wave speeds of 3000, 4500 and 6000 m/s. The first layer T1 may have a thickness frequency of 10 kHz, T2 of 11.25 kHz and 3rd thickness frequency of 16.6 KHz. In one example, the thickness frequencies can be below 20 KHz, and an accumulation of the thickness frequencies of the three layers can be below 10 kHz. Emitting such high frequencies may allow higher resolution responses for thin layers of less than 150 mm.

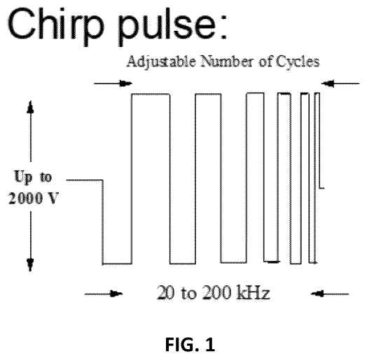

The duration of sweep pulse may be programmed based on the thickness, material and/or mechanical properties of the one or more layers. In an example, the sweep pulse duration may be 5 milliseconds. In other examples, the duration of the sweep pulse may be more or less than 5 milliseconds or up to 10 milliseconds. Over the duration of the sweep pulse, the frequency of the pulse increases from the lower limit to the upper limit. FIG. 1 shows an example chirp pulse where the frequency increases over a set duration from 20 kHz to 200 kHz. The emitting (transmitting) chirp pulse (the bandwidth of the pulse) contains frequencies that are higher than the thickness frequencies returned that the receiving sensor captures. In this way, the wavelengths are smaller than the thickness of each layer and the accuracy in measurements can be achieved.

The sweep pulse may be generated by a piezoelectric ultrasonic transducer or by a magnetic solenoid, or solenoid vibrator. In an example, a piezoelectric crystal may be used. In another example, a solenoid transducer may be used. The vibration of the sweep pulse generator may be selected to correspond to the desired excitation frequency. The generated sweep pulse emits a low-to-high (or high-to-low) frequency sweep in the ultrasonic range, in which the bandwidth contains all of the thickness frequencies in the multi-layered structure. By generating the sweep pulse, the parameters of the pulse are known such as frequency and power. The sweep pulse contains the thickness frequency of each layer as well as the thickness frequency of the overall structure. The thickness frequency of the overall structure is the sum of the thickness frequencies of all of the layers in the structure. For example, the emitted sweep pulse contains frequencies that are higher than the thickness frequencies being reflected and received at a receiver. In this way, the wavelengths are smaller than the thickness of each layer allowing for accuracy in measurements. The sweep pulse may also generate vibrations and pulses resulting in a lower or higher frequency bandwidth than the 20-200 kHz bandwidth that was emitted, which may enable the receiver to detect thickness frequencies at much lower or higher frequencies that are reflected off of the boundary of each of the layers in the multi-layered structure. If the half wavelength of the emitted sweep pulse is longer than the thickness of a layer, the layer boundary will not ‘see’ this signal and the layer will not provide a return signal. As such, the emitted wavelengths should be smaller than the thickness of the layer and the detected thickness frequencies will be lower than the emitted frequencies, for example the thickness frequencies may be less than 20 kHz. In an example, the detected thickness frequencies can also be higher by detecting 2nd, 3rd, etc. modes/harmonics of this thickness frequency, where a mode (m) is a multiple of a thickness frequency (f) (i.e. m1=f, m2=2f, m3=3f). In an example, if the thickness frequency is m1=10 kHz, the presence of a m2=20 kHz, m3=30 kHz, etc., may also be detected.

Using a frequency sweep pulse from an ultrasonic wave-transmitting device allows for greater control over the frequency of the pulses being emitted and therefore may result in more accurate knowledge of the parameters of the frequency pulse, and more accurate measurements of reflections of that pulse as compared to, for example, a pulse created by an impact hammer. Accurate measurements may be achieved, for example, by ensuring an emission of an array of frequencies that have wavelengths small enough to be seen by the thin layers of the industrial structures. Higher frequencies, however, tend to attenuate or lose energy faster, so frequencies need to be selected not only to have wavelengths that are sufficiently small to be seen by the thin layers on the one hand, but not too small such that they can transmit through the material of the layer(s). Furthermore, the emitter must generate acoustic waves having amplitude sufficiently large so they are not dissipated in the industrial structure's materials like coarse-grained material(s). A broad array of frequencies may be generated using the ultrasonic emitter to help ensure that some frequencies meet this criteria for all of the thicknesses of the layers.

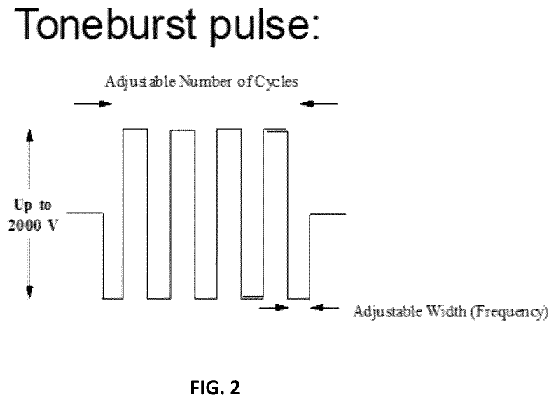

An example toneburst pulse waveform is shown in FIG. 2. The toneburst pulse is a strong one-punch ultrasonic pulse that contains a frequency bandwidth but the frequency bandwidth does not necessarily match the thickness frequencies of the multi-layered structure and therefore may not provide the accuracy that may be achieved by a sweep pulse such as a chirp pulse.

After the pulse is emitted into the multi-layered structure using the ultrasonic transmitter, the pulse travels through the structure, causing the layers to emit acoustic waves having thickness frequencies back to an ultrasonic broadband receiver. The ultrasonic broadband receiver can detect reflections of the emitted pulses corresponding to the thickness frequencies of each of the layers of the multi-layered structure. The ultrasonic broadband receiver may have a different frequency range as compared to the ultrasonic broadband transmitter. The ultrasonic broadband receiver may have bandwidth with broader frequency ranges as compared to the broadband transmitter to be able to detect lower or higher frequencies generated by the pulses as a result of vibrations of the layers. For example, the transmitter may emit frequencies in the range of 20 kHz to 200 kHz, whereas the receiver may receive back frequencies or reflections, in a different or broader range, for example as low as 3 kHz and as high as 1200 kHz. Each of the different layer thicknesses would produce its own unique reflection or back frequency. The back frequencies that are received by the receiver are therefore related to the thickness of each layer, wherein the thicker the layer, the lower the frequency. The frequency returned back from a layer as a result of stimulation by transmitted ultrasonic wave frequencies may be referred to herein as the thickness frequency, or actual thickness frequency, of the layer.

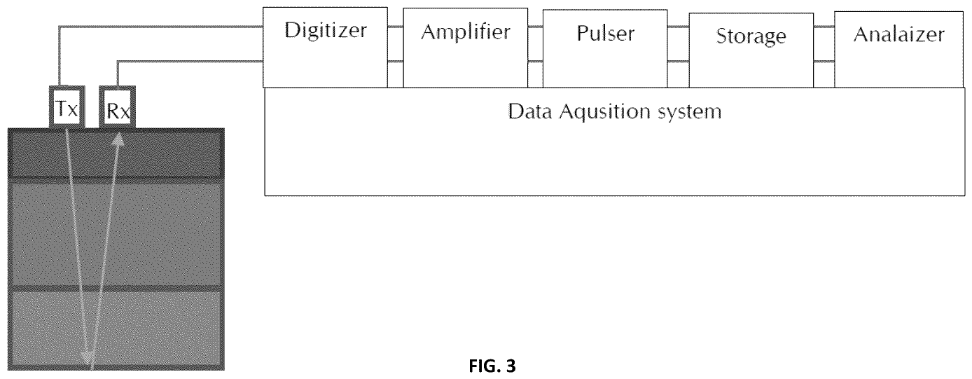

In an example as shown in FIG. 3, a data acquisition system connected to the transmitter (Tx) and receiver (Rx) may be used. The data acquisition system may comprise any one or more of a digitizer, an amplifier, a pulser, storage and an analyzer. The data acquisition system may be used to compare, for example, the thickness frequencies received by the broadband receiver over time to determine increases (or decreases) in thickness frequency of a layer of the multi-layer structure. For example, an increased frequency indicates that the layer thickness has decreased, for example due to erosion or wear of the layer. A decreased frequency indicates that the layer thickness has increased (less common) but may be due to expansion of the layer for any reason. The resonance of the ultrasonic waves within the single layer or multi-layers generate the thickness frequency of a single layer or multilayers. This single or multilayered thickness frequency could be in ultrasonic or acoustic bandwidth and depends on the thickness, material properties and the stress wave speed in the single or multi-layered structure.

In an aspect, the method as disclosed herein may be used to determine the wear state of or changes in at least one of the layers of a multi-layered structure based on the thickness frequency measured being higher or lower than a theoretical thickness frequency of the structure or of the layer. The theoretical thickness frequency is the single thickness frequency of the structure or layer that is expected to be returned for a layer, such as before any wear or changes to the layer when the structure or layer is in a like new condition. The theoretical thickness frequency for a layer is not a range of potential frequencies but is an expected single thickness frequency. The theoretical thickness frequency may be identified based on a known thickness of the structure or layer and/or material type before any wear or change, or may be identified based on obtaining an actual thickness frequency in accordance with embodiment(s) disclosed herein, or may be identified based on a calculated thickness based on a known longitudinal wave speed of the pulse emitted into the structure. The theoretical thickness frequency can then be used as a marker or baseline to help determine whether the thickness frequency of the structure and specifically any layer, has changed which indicates a change in the layer itself. For example, the thickness of the layer furthest away from the transducer emitting the pulse may be desired. To determine the thickness of this last layer, the overall frequency of the multilayered structure is subtracted from the frequency of the layers that it has passed through, before the last layer. The thickness of the last layer can then be calculated as the difference.

A pulse transmitter or transducer according to embodiments as described in this disclosure, may be controlled to generate a “chirp” or create a frequency sweep, or a toneburst pulse, within a very short period of time, for example, 5 milliseconds. In such a case, the receiver must be broadband enough to capture the acoustic signals reflected from the internal layers of the multi-layered structure within 5 milliseconds, as the duration of pulsing and receiving must remain within 10-20 milliseconds. In an embodiment, a layer of a multi-layer structure is defined by a boundary where the materials differ. A high signal strength is necessary in order to penetrate layer(s) in a multi-layered industrial structure comprising coarse-grained material. The signal strength refers to the amplitude of the waves of the signal. Signal strength may be described with reference to the voltage that is provided to an ultrasonic emitter to generate the ultrasonic signal. For example, to achieve a high signal strength (above normal ultrasonic signal strength ranges), more than 500 volts, or more than 1000 volts, or more than 2000 volts may be provided to the ultrasonic emitter. In addition to selecting a desired frequency range, the emitted signal is selected to have sufficient energy (strength) to be able to penetrate to the furthest layer of the multi-layer structure and back again. The lower the energy of the signal, the lower the amplitude of the signal wave. If the energy of the signal is too low, it may be completely attenuated such that the waves disappear within the multi-layered structure. In particular and by contrast, very thin structures, for example those that are in the micrometer range or 10 mm or less, do not need to balance the energy output of the signal with the frequency, since a very low energy signal will be able to propagate through the very thing micrometer thick structure and reflect without being attenuated. The reflected energy of the signal may also be used to qualify the material of the layers of the multi-layered structure. For example, an emitted high signal strength that returns relatively high, could be an indication of good, material that has not been worn down. An emitted high signal strength that returns relatively low may be an indication of poor material wherein the signal was attenuated throughout the propagation and reflection.

In a metallurgical furnace example, such as a blast furnace for example, the multi-layered structure may include a cast iron shell, castable grout, and a cast iron or cast copper stave, which all comprise coarse-grained material. Other coarse-grained composite material include for example, concrete, wood, rock, refractory brick, and bone. In an example where the furnace wall is 250 mm thick, for example a shell of about 50 mm, castable grout of about 50 mm and a stave cooler of about 150 mm, the pulse strength must be strong enough and remain at this strength equally throughout the whole thickness of 250 mm in order to measure the last layer (stave) thickness, otherwise, the resulting frequency amplitude will be affected.

In an aspect of this disclosure, an ultrasonic system for determining wear in a last layer or innermost layer of a multi-layered industrial structure is disclosed. The system may comprise a pulser (pulse transmitter) positioned on a first layer or outermost layer or an outside of a structure, farthest away from the last layer. One or more other layers may be between the first and last layer of the multi-layered structure. At least one, and optionally more than one, of the layers comprise a coarse-grained material. The coarse-grained material may be a composite material. The pulser may be a piezoelectric crystal or other piezoelectric ultrasonic pulser, or may be a magnetic solenoid or other programmable vibrating solenoid. The pulser is caused to emit an ultrasonic pulse with a select bandwidth, such as a frequency sweep pulse or a broadband pulse or chirp or toneburst, through the multi-layered structure, the ultrasonic pulse being unique to the structures thickness frequencies, mechanical properties, and material properties, for each of the layers. An ultrasonic broadband receiver is also positioned on the first layer or the outside of the multi-layered structure and receives thickness frequency information for the multi-layered structure from the reflecting ultrasonic pulse. An analyzer compares the received thickness frequencies for each of the layers (or a selected layer) with known or calculated theoretical or historical thickness frequencies for each of the layers (or for a selected layer) before being subjected to a wear environment.

In an example, the distance between the broadband transducer and broadband receiver is sufficiently close to enable the devices to act as a point transmitter/receiver system. The distance between transmitter and receiver on the same surface is preferably less than 70 mm, for example less than 60 mm, or less than 50 mm, or less than 40 mm, or less than 30 mm, or less than 20 mm. The frequency bandwidth between the transmitter and receiver could be the same or the receiver may have a broader bandwidth range. With a broader frequency range the transmitter may be able to capture lower or higher thickness frequencies in the acoustic range, that are the result of vibrations.

In an example, the system and method for measuring layer thickness as described herein may be used to measure, from outside of the furnace, the thickness of the walls of a stave cooler encased in the refractory of the furnace. The furnace may be operational such that the inside wall is hot. The wall thickness of a stave cooler is typically about 150 mm thick. An ultrasonic transducer or magnetic solenoid may be programmed to emit a frequency sweep into the shell of the furnace. The frequency sweep can be selected to include the thickness frequency of each layer moving inwards from the blast furnace shell to the inside of the furnace, for example the frequency sweep may include the thickness frequencies of the shell, of the stave cooler walls, and of the refractory brick layer and ramming (paste) between the shell and the stave cooler walls. Periodic measurements of the thickness based on a sum of the thickness frequencies can be used to determine whether there has been any erosion to the stave walls. For example, as iron and coke is added to the blast furnace, these pellets tend to erode the inner walls of the furnace, as the walls erode, the stave coolers become exposed to the hot metal and abrasive forces. Periodic thickness measurements as disclosed herein can be used to compare the overall thickness frequencies collected over time to determine if any change has occurred. Since each overall thickness frequency includes the sum of each individual layer's thickness frequency, a technician could determine which layer's thickness frequency has changed. A thinner layer produces a higher frequency; accordingly, if the stave cooler wall is eroding and becoming thinner, the thickness frequency of that layer will increase proportionally. The receiving signals are collected by a broadband transducer or a vertical displacement transducer or an accelerometer. The bandwidth of the receiving transducer could be of the same bandwidth as the transmitting transducer or wider. The receiving transducer bandwidth may be for example of a range that matches the thickness frequencies for the single and multi-layered structure, and ultimately the full theoretical thickness of the structure. The frequency bandwidth of the receiving transducer may be in acousto ultrasonic range.

The signals may be collected in time-domain but dominantly the signal analysis is carried out in frequency-domain. The analysis could also be done in time-domain or in a combination of time and frequency-domain. The receiving frequencies are analyzed and pick frequencies are selected. There will be pick frequencies matching the precalculated theoretical thickness frequencies or will be very similar. The further thickness frequency or the inner thickness frequency is the desired resulting frequency that determine the thickness of the final layer's thickness. Shape, temperature and vibration correction coefficients may be used to more accurately determine position, layer thicknesses, overall thickness, location of cracks, delamination, joints, chemical changes, and/or material changes, within a layer or between layers of a multilayered structure.

In an embodiment, the system and method as disclosed herein may be used to evaluate layers so as to determine the position of a delamination, crack, joint, or flaw between any of the layers in the multi-layered structure or within any one or more of the layers of the multi-layered structure. The system and method may also be used to detect the changes in crack position, size, propagation and condition within a layer or between layers in the multi-layered structure. For example, the system and method may be used to detect the position of penetrated molten metal, within a single layer or between layers in a multi-layered structure. The system and method may be used to determine the location and position of chemical changes in the material, or to detect and distinguished between unaltered refractory, altered refractory, or metal impregnated refractory within one layer or in between layers in the multi-layered structure. The system can also detect build-up or skull formation at the hot face of metallurgical furnace. In each case, the artifact, anomaly or change in the multi-layer structure generates a reflection of the sweep pulse, similar to reflections previously discussed in this disclosure that occur at layer boundaries. A thickness frequency that corresponds to a thickness or distance at the location of the artifact, anomaly or change. For example, a crack is a discontinuity which may cause a reflection of a wave. The reflection measures the distance from source to crack. Similarly, metal penetration and delamination would cause a reflection that may be measured. If there is a change in material properties for example by chemical attacks, the responding thickness frequency would also change. In an example, the material changes in layers may further be detected by comparing the input signal strength and output signal strength of the sweep pulse.

In further embodiments, a system and method is provided for estimating the thickness and wear state of a refractory material in a metallurgical furnace. Ultrasonic waves may be generated such that the waves propagate into the refractory material. Ultrasonic wave sensors may be used to sense at least one reflected wave into the refractory material. A database of theoretical thickness frequency domain data, for example, simulated spectra, may be used to represent simulated waves reflected in simulated refractory materials of known state and thickness. Each simulated spectrum may be correlated with both known state and thickness data of the simulated refractory material. A processing means may be carried out in order to record the reflected wave as a time domain signal, and to convert it into frequency domain data to produce, for example, an experimental spectrum. Processing means may also be used to compare the experimental spectrum of thickness frequencies for multiple layers with a plurality of simulated spectra from the database. This processing means may be further used to sequentially determine resonant frequency peak positions in the frequency domain data and/or to filter the simulated spectra from the database with the resonant frequency peaks and select a reduced corresponding group of simulated spectra comprising said resonant frequency peaks. The resonance frequency peak may be generated due to the reflection of elastic, shock or stress waves between two structural element boundaries. The structural element boundaries could be defined and caused by single or multi-layered thickness, delamination, and cracks. The resonance frequency peak could be referred to as the thickness frequency. The elastic or stress wave sensor may be for example, an accelerometer or directional transducer configured to measure the mechanical reaction of the refractory material caused by the reflection of the generated elastic or stress wave. The plurality of reflected waves may be sensed and recorded as time domain signals, and converted into frequency domain signals.

In another embodiment, a method is provided for estimating both thickness and wear state of a refractory or cooling element material of a metallurgical furnace. The method may comprise, generating an elastic or stress wave that propagates into refractory material, sensing a reflected wave into the refractory material, recording the reflected elastic or stress wave as a time domain signal, converting the time domain signal into frequency domain data, for example as may be referred to as an experimental spectrum and comparing the experimental spectrum with at least a plurality of simulated spectra from the database, each simulated spectrum being correlated with both known state and thickness data of the considered refractory material. The method may further comprise comparing the experimental spectrum with the plurality of simulated spectra and determining resonant frequency peak positions in the experimental spectrum, filtering the simulated spectra from the database with the resonant frequency peaks detected, and selecting a reduced corresponding group of simulated spectra comprising said resonant frequency peaks. This allows for determining a unique simulated spectrum from the reduced corresponding group, whose resonant frequency peaks are the closest in height to those of the experimental spectrum.

Estimating the thickness and/or the state of the refractory material may be performed by estimating the total thickness of the refractory material and the position and thickness of at least a layer in which the refractory is weakened by anomalies, said layer being named brittle layer. Further, determining the resonant frequency peak positions in the experimental frequency spectrum may be achieved by arithmetically averaging the experimental spectra and selecting a first set of representative peaks, geometrically averaging the experimental spectra and selecting a second set of representative peaks and selecting a final set of peaks that were both selected in the first set and the second set, said final set of peaks being the resonant frequency peaks of the thickness frequencies. In an example, the peaks of the first set may be selected if their width is greater than a threshold value between ten and twenty hertz.

The simulated spectra from the database may be filtered with the resonant frequency peaks detected using at least a numerical dispersion curves model in order to determine propagation modes of the waves, to filter them with the resonant frequency peaks detected, and to select the reduced corresponding group of simulated spectra. Further, the unique simulated spectrum may be determined from the reduced corresponding group using at least a numerical transient model. The spectra of the reduced corresponding group may be selected then compared with the experimental spectrum by implementing at least one of the following steps, (1) evaluating the direct difference between simulated spectra and experimental spectrum for a layer; (2) comparing the overall shape of the simulated spectra and of the experimental spectrum for a layer; (3) determining the differences between the maximum height peak positions of respectively the simulated spectra and the experimental spectrum for a layer; and/or (4) cross correlating between the simulated spectra and the experimental spectrum for a layer.

In another embodiment, a method of detecting crack propagation in a wall of a metallurgical furnace by a detection unit is provided. The method may comprise transmitting, by an ultrasonic signal generating unit of the detection unit, a stress signal into the wall, for example at one or more locations on the wall of the metallurgical furnace, receiving, by the detection unit, a reflected stress signal from each of the one or more locations based on the corresponding stress signal, extracting, by the detection unit, one or more dominant frequency parameter from the corresponding reflected stress signal, from each of the one or more locations and analyzing, by the detection unit, a phase from each of the one or more dominant frequency parameters for a corresponding location of the one or more locations. The analyzing of the phase step may comprise for example, determining, by the detection unit, one or more coefficients for each of the one or more dominant frequency parameters based on the reflected stress signal and a reference signal, identifying, by the detection unit, a dominant phase for each of the one or more dominant frequency parameters based on the corresponding one or more coefficients, selecting, by the detection unit, a frequency relevant to a thickness parameter from the one or more dominant frequency parameters for the corresponding location on the wall, based on the dominant phase, and detecting, by the detection unit, the crack propagation in the wall of the metallurgical furnace based on the frequency relevant to the thickness parameter at each of the one or more locations.

The method may further comprise determining a crack propagation in the wall by, for example, computing a thickness value based on the frequency relevant to the thickness parameter and comparing the thickness value of one location of the one or more locations with the corresponding thickness value at another location of the one or more locations, to determine the crack in the wall. The thickness value may for example correspond to thickness of each of a plurality of layers in the wall at the one or more locations.

The method may further comprise modulating the reflected stress signal with the reference signal for determining the one or more coefficients for each of the one or more dominant frequency parameters, and/or computing each of the one or more coefficients, by incrementing each of one or more predefined phase values in the reference signal, wherein the one or more predefined phase values ranges from about 0 degrees to about 360 degrees. In addition, the method may further comprises, generating a coefficient plot based on the one or more coefficients and the one or more predefined phase values for identifying the dominant phase for each of the one or more dominant frequency parameters, wherein one or more peak values of the coefficient plot may be detected for identifying the dominant phase. The reflected stress signal as defined in this method may be a time-domain parameter and the method may comprise converting the reflected stress signal in the time domain parameter to a frequency domain parameter.

In a further example embodiment, a detection unit for detecting crack propagation in a wall of a metallurgical furnace is provided. The detection unit may comprise for example, a signal generating unit for transmitting a ultrasonic stress signal to propagate in the wall at one or more locations on the wall of the metallurgical furnace, a processor, and a memory, communicatively coupled to the processor, wherein the memory stores processor-executable instructions. The instructions may be used to cause the processor to receive a reflected stress signal for each of the one or more locations based on the corresponding stress signal, extract one or more dominant frequency parameters from the corresponding reflected stress signal, for each of the one or more locations, and analyze a phase, of each of the one or more dominant frequency parameters for a corresponding location from the one or more locations. The analysis may comprise, for example, a determination of one or more coefficients for each of the one or more dominant frequency parameters based on the reflected stress signal and a reference signal, identification of a dominant phase for each of the one or more dominant frequency parameters based on the corresponding one or more coefficients and a selection of a frequency relevant to a thickness parameter from the one or more dominant frequency parameters for the corresponding location of the one or more locations on the wall, based on the dominant phase. The instructions may further cause the processor to detect the crack propagation in the wall of the metallurgical furnace based on the frequency relevant to the thickness parameter at each of the one or more locations. The detection unit may comprise at least one sensor unit for receiving the reflected stress signal from the wall and may be used to determine the crack propagation in the wall by computing a thickness value based on the frequency relevant to the thickness parameter, wherein the thickness value corresponds to thickness of each of a plurality of layers in the wall at the one or more locations and comparing the thickness value of one location of the one or more locations with the corresponding thickness value at another location of the one or more locations, to determine crack propagation in the wall.

1. A method of evaluating a multi-layered industrial structure, the method comprising,
identifying a single theoretical thickness frequency for a layer within the multi-layered structure;
emitting an ultrasonic frequency sweep pulse or an ultrasonic broadband pulse into the multi-layered industrial structure, the pulse having known frequencies based on the single theoretical thickness frequency;
detecting, using an acousto ultrasonic broadband receiver, an actual thickness frequency of the layer within the multi-layered structure as returned by the multi-layered structure in response to the frequency sweep pulse; and,
comparing the actual thickness frequency with the theoretical thickness frequency to identify a change in the layer of the multi-layered industrial structure.

2. The method of claim 1 wherein the frequency sweep pulse is in the low frequency ultrasonic range.

3. The method of claim 1, wherein the multi-layered industrial structure comprises a layer composed of a coarse-grained material.

4. The method of claim 1, wherein the frequency sweep pulse or broadband pulse comprises an ultrasonic signal strength capable of causing a reflection of a thickness frequency in the layer with coarse-grained material.

5. The method of claim 1, wherein the frequency sweep pulse or broadband pulse comprises an ultrasonic signal strength capable of causing a reflection of a thickness frequency in the layer having a thickness of at least 20 mm.

6. The method of claim 1, wherein the frequency sweep pulse or broadband pulse comprises an ultrasonic signal strength of at least 500 volts, or at least 1000 volts, or at least 2000 volts.

7. The method of claim 1 wherein the frequency sweep pulse comprises wavelengths whose half wavelength is smaller than the thickness of a thinnest layer of the multi-layered structure.

8. The method claim 1 wherein the multi-layered structure has a total thickness of no more than 600 mm and no less than 20 mm.

9. The method claim 1, further comprising emitting the frequency sweep pulse to have known frequencies based on the single theoretical thickness frequency of each of the layers in the multi-layered industrial structure.

10. The method of claim 1, further comprising emitting the pulse to have known frequencies based on properties of any one or more of the layer(s) of the multi-layered industrial structure.

11. The method of claim 1, wherein a duration of the frequency sweep pulse is determined based on the thickness and material properties of the multi-layered industrial structure.

12. The method of claim 1, wherein the frequency sweep pulse is emitted from a piezoelectric ultrasonic transducer or a magnetic solenoid.

13. The method of claim 1 wherein the multi-layered industrial structure is a lining or wall of a metallurgical furnace, a glass furnace, a chemical process vessel, another hot vessel, a pipe, or rotary kiln.

14. The method of claim 1, further comprises determining a wear state of at least one of the layers based on the actual thickness frequency being higher than the theoretical thickness frequency.

15. The method of claim 1, wherein the at least one layer of the multi-layered structure is the layer farthest away from where the frequency sweep pulse is emitted into the structure.

16. The method of claim 1, wherein the frequency sweep pulse is in the range of between about 20 kHz and about 200 KHz.

17. The method of claim 1, wherein the changes being evaluated are changes in thickness, material and/or mechanical properties of the multi-layered structure.

18. The method of claim 1 wherein the change in the layer is an artifact, crack, delamination, joint, or chemical change.

19. An ultrasonic system for evaluating a layer of a multi-layered industrial structure, the system comprising,
an ultrasonic pulser positioned on an outermost layer of the multi-layered industrial structure, wherein the outermost layer is furthest away from an innermost layer, the pulser for emitting an ultrasonic frequency sweep pulse or an ultrasonic broadband pulse into the multi-layered industrial structure, the pulse having known frequencies based on a single theoretical thickness frequency of the layer,
an acousto ultrasonic broadband receiver for receiving an actual thickness frequency from the multi-layered industrial structure in response to the frequency sweep pulse or broadband pulse, and
an analyzer for comparing the actual thickness frequencies with the theoretical thickness frequency of the layer of the multi-layered industrial structure to identify a change in the layer.

20. The system of claim 19, wherein the pulser is configured to emit a frequency sweep pulse or a broadband frequency pulse into the multi-layered structure.

21. The system of claim 19, wherein the frequency sweep pulse is a broadband pulse or a chirp pulse.

22. The system of claim 19, wherein the thickness frequencies are received by the acousto ultrasonic broadband receiver in the time-domain but the analyzer performs analysis the time domain and/or the frequency-domain.

23. The system of claim 19, wherein the multi-layered industrial structure is a lining or wall of a metallurgical furnace, a glass furnace, a chemical process vessel, another hot vessel, a pipe, or rotary kiln.

24. The system of claim 19, wherein the multi-layered industrial structure is a coarse-grained composite material that comprises at least one layer of coarse-grained material or comprises a combination of coarse-grained and fine-grained materials.

25. The system of claim 19, wherein the multi-layered structure has a total thickness of no more than 600 mm and no less than 20 mm.

26. The system of claim 19, wherein the frequency sweep pulse or broadband pulse comprises an ultrasonic signal strength capable of causing a reflection of a thickness frequency in the layer with coarse-grained material.

27. The system of claim 19, wherein the pulser is configured to provide an ultrasonic signal having a strength capable of causing a reflection of a thickness frequency in the layer having a thickness of at least 20 mm.

28. The system of claim 19, wherein the pulser is configured to provide an ultrasonic signal having a strength of at least 500 volts, or at least 1000 volts, or at least 2000 volts.

29. The system claim 19 wherein the change in the layer is an artifact, crack, delamination, joint, or chemical change.
